(19) United States
(12) Patent Application Publication
(10) Pub. No.: US 2020/0123478 A1
(43) Pub. Date: Apr. 23, 2020

(54) EMULSION-TYPE WATER-BASED DETERGENT FOR OILY SLUDGE, PREPARATION METHOD AND USE METHOD THEREOF

(71) Applicants: SHANDONG UNIVERSITY, Jinan (CN); SHOUGUANG XINHAI ENERGY TECHNOLOGY CO., LTD., Weifang (CN)

(72) Inventors: Tao Wu, Jinan (CN); Maoxin Wang, Jinan (CN); Yachao Zhu, Jinan (CN); Dejun Sun, Jinan (CN); Jianhua Zhou, Weifang (CN); Pengcheng Wei, Jinan (CN)

(21) Appl. No.: 16/603,954

(22) PCT Filed: May 2, 2018
(86) PCT No.: PCT/CN2018/085284

§ 371 Date: Oct. 9, 2019

(30) Foreign Application Priority Data
Jul. 10, 2017 (CN) 20170558112.2

(51) Int. Cl. C11D 17/00; C11D 1/29; C11D 1/00; C11D 3/43; C11D 3/04; C11D 11/00; B01D 17/04; C02F 11/147

(52) U.S. Cl. CPC C11D 17/0021; C11D 1/29; C11D 1/008; C11D 3/43; C02F 2103/10; C11D 11/0094; B01D 17/047; C02F 11/147; C11D 3/046

(57) ABSTRACT

The present invention discloses an emulsion-type water-based detergent for oily sludge, and a preparation method and use method thereof. The emulsion-type water-based detergent includes components in the following mass percentage contents: 2-10 parts of surfactant, 3-10 parts of oil-soluble component and the balance being aqueous phase, based on 100 parts by weight. The preparation method includes: stirring the surfactant, the oil-soluble component and the aqueous phase to mix uniformly to obtain a homogeneous and stable emulsion-type water-based detergent at room temperature. During use, the oily sludge is first mixed with the emulsion-type water-based detergent and stirred under a certain temperature; mixture is subjected to oil-water-solid three-phase separation after the washing is completed; and at last, solid phase is rinsed with hot water under the same temperature.

### TECHNICAL FIELD

The present invention relates to an emulsion-type water-based detergent for oily sludge washing, simultaneously relates to a preparation method and use method of the water-based detergent, and belongs to the technical field of oily sludge washing.

### BACKGROUND

The oily sludge is a solid waste generated in exploitation, storage, transportation and refinement of petroleum and treatment of oily sewage. Except for petroleum hydrocarbons, it further contains toxic and harmful substances such as benzenes, phenols and heavy metal salts. The oily sludge not only occupies the land and space, but also pollutes air, soil and underground water seriously if not treated and directly discharged. It has been listed into the National Catalogue of Hazardous Wastes and has restricted the development of domestic oilfield production to some extent. Meanwhile, the oily sludge is also a kind of resource. If a treatment technology capable of removing a hazard of the oily sludge to environment and recycling a useful resource therein is developed, it will be of great practical significance to sustainable development of an oilfield.

There are a variety of treatment technologies for the oily sludge. At present, the known methods for treating the oily sludge at home and abroad mainly include resource recycling technology, harmless treatment technology and comprehensive utilization technology. Among them, the resource recycling technology includes solvent extraction method, thermal washing method, surfactant aqueous solution washing method, micro-emulsion washing method, chemical demulsification method, solid-liquid separation method, etc.; the harmless treatment technology includes solidification treatment method, biological treatment method, incineration method, etc.; and the comprehensive utilization technology includes thermal decomposition, brickmaking and road pavement, etc. However, each of the treatment methods has its advantages and disadvantages. For example, the commonly-used solvent extraction method can recycle most of oil phase in the oily sludge, but extractant is expensive, a certain loss is caused inevitably in the process of treatment, and the problem of a potential safety hazard also exists. With the incineration method, an organic matter may be treated thoroughly, and the heat energy produced in an incineration process can be effectively utilized. However, a certain amount of combustion-supporting oil and a special incineration device are required in the treatment process, and waste gas and waste residue are further discharged to cause secondary pollution possibly. The thermal washing method, the surfactant aqueous solution washing method, the micro-emulsion washing method and the like have the advantages of simple operation method, less investment in equipment, low requirement on an experimental condition, and so on, and can further recycle an oil phase in the oily sludge effectively, and thus have got certain applications in industry.

There are many application examples on relevant treatment technologies of the oily sludge in China and foreign countries. For example, a Chinese patent literature CN104310734A discloses an oily sludge treatment agent. With the agent, the oil-water interfacial tension is effectively reduced at room temperature, the treatment effect for the oily sludge is good, and the recycling rate of an oil phase can be up to 96% or more. However, a bio-enzyme such as a protease and a lipase is added to a formula of the oily sludge treatment agent, resulting in that it is sensitive to a temperature change to play the performance of the agent adversely. A Chinese patent literature CN106277709A discloses an environment-friendly detergent for treating oily sludge. When the addition amount of the detergent is 2 wt % of the oil sludge by weight, the final oil recovery rate is up to 95.9% and the treatment effect is good. Nonetheless, the defects lie in that many substances are added to the detergent, even up to three kinds of surfactants are provided, and the ratio of water to the oily sludge is large, all of which increases the difficulty in a treatment process and causes the resource waste to a certain degree. A U.S. patent literature US20150068950A1 introduces a water-in-oil type nanoemulsion prepared from an alkyl glycoside surfactant to treat the oily sludge. The nanoemulsion has a low interfacial tension; and nano-sized water droplets in the emulsion are dispersed and adsorbed to the surface of a solid more easily to accelerate the recovery of oil phase. However, when the nanoemulsion is used for treating several different kinds of oily sludge, the oil removal efficiency is unremarkable, and the oil removal efficiency is only 65.8% at maximum and 10.3% at minimum, so that a further application of the nanoemulsion is restricted. A U.S. patent literature US20090221456A1 reports a method for cleaning oily sands with microemulsion. When the addition amount of surfactant is 1-5 wt %, the oil content of the oily sands can be reduced to 0.52% at minimum. Nevertheless, when temperature rises to cloud point of the surfactant solution, the phase separation occurs and the washing efficiency is reduced significantly; and thus the microemulsion system is sensitive to the change of temperature.

At present, most of detergents for the oily sludge are surfactant aqueous solutions.

### SUMMARY

For defects of the existing oily sludge treatment agent, the present invention provides an emulsion-type water-based detergent for oily sludge with stable property, safety, efficiency and good washing effect, and simultaneously provides a preparation method and use method of the detergent.

An emulsion-type water-based detergent for oily sludge provided by the present invention includes 2-10 parts of surfactant, 3-10 parts of oil-soluble component and the balance being aqueous phase, based on 100 parts by weight.

The surfactant includes sodium fatty alcohol-polyoxyethylene ether sulfate (AES) and a super-amphiphilic molecular emulsifier. The mass ratio of the AES to the super-amphiphilic molecular emulsifier is 1:4-4:1, and preferably 1:1-2:1. The AES is also referred to as sodium ethoxylated alkyl sulfate or sodium alcohol-ether sulfate, the structural formula is RO(CH₂CH₂O)ₙSO₃Na (the R is C12-14 alkyl, n=2-3), the quality standard refers to GB/T 13529-2011 Sodium Ethoxylated Alkyl Sulfate, and the content of active substances is 68-72%. The super-amphiphilic molecular emulsifier may use a super-amphiphilic molecular emulsifier in Super-Amphiphilic Molecular Emulsifier Having Responsiveness, Emulsion and Preparation Method Thereof disclosed by a Chinese patent literature CN105542149A.

The oil-soluble component is methylbenzene, dimethylbenzene, mixed benzene, diesel oil, paraffin oil or gas-to-liquid.

The aqueous phase is pure water, or NaCl solution having a concentration of less than 1 wt %, or CaCl₂ solution having a concentration of less than 0.1 wt %, or NaCl and CaCl₂ mixed solution having a concentration of NaCl being less than 1 wt % and the concentration of CaCl₂ being less than 0.1 wt %.

A method for preparing the above emulsion-type water-based detergent for the oily sludge includes the following steps:

based on 100 parts by weight, taking 2-10 parts of surfactant, 3-10 parts of oil-soluble component and the balance being aqueous phase; and mixing the above components and stirring uniformly to obtain the homogeneous and stable emulsion-type water-based detergent. The agitation speed is 150-500 rpm, the stirring time is 25-40 min, and the stirring temperature is a room temperature.

A method for using the above emulsion-type water-based detergent for the oily sludge includes the following steps:

mixing the oily sludge with the emulsion-type water-based detergent according to a mass ratio of 1:3-1:8, stirring under 60-80° C., washing the oily sludge, subjecting a mixture to oil-water-solid three-phase separation after washing is completed, and at last, rinsing a solid phase with hot water under a temperature same as the stirring temperature. The stirring time is 10-40 min, the agitation speed is 200-500 rpm, and the rotational speed in the three-phase separation is 1500-2500 rpm.

The emulsion-type water-based detergent for the oily sludge prepared by the present invention is safe and efficient, simple in the method of preparation, wide range in application, and easy to implement an industrial application. An experiment indicates that the treatment effect to the oily sludge is good.

### BRIEF DESCRIPTION OF THE DRAWINGS

FIG. 1 is a sample diagram of an emulsion-type water-based detergent for oily sludge prepared in an embodiment 1 of the present invention.

FIG. 2 is a comparison diagram of a use effect in an embodiment 1 of the present invention, (a) original picture of oily sludge, and (b) picture of oily sludge after treatment.

FIG. 3 is a comparison diagram of a use effect in an embodiment 5 of the present invention, (a) original picture of oily sludge, and (b) picture of oily sludge after treatment.

### DETAILED DESCRIPTION

### Embodiment 1

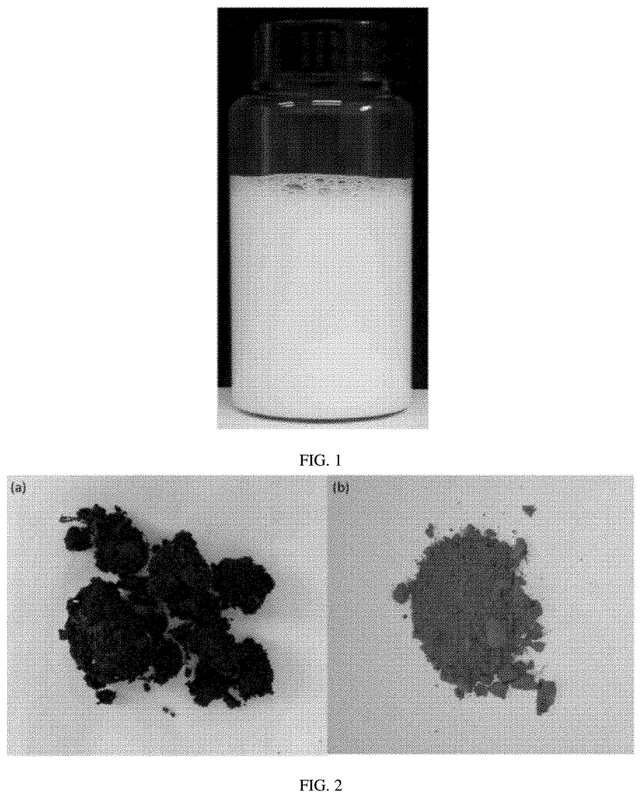

Based on 100 parts by weight, 5 parts of AES and 5 parts of super-amphiphilic molecular emulsifier according to a mass ratio of 1:1, 10 parts of methylbenzene and 80 parts of pure water were weighed respectively, put into a reactor sequentially, and stirred for 40 min at agitation speed of 500 rpm under room temperature to form a homogeneous and stable emulsion-type water-based detergent, with a sample shown in FIG. 1.

The oily sludge was taken from the Liaohe oilfield, with the initial parameters including 57.20% of oil content, 38.98% of solid content and 3.82% of water content (all percentage contents were based on the weight), and the macrophotograph shown in FIG. 2(a).

Washing effect test: the mass ratio of the oily sludge to the water-based detergent was 1:4; the detergent was used for washing the oily sludge twice, 30 min for each time, at an agitation speed of 500 rpm under 80° C.; then, hot water with 80° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 2500 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing results are shown in the table below, and the treated sludge is shown in FIG. 2(b).

| | |
|---|---|
| Initial oil content/% | 57.20 |
| Residual oil ratio/% (g/100 g | 0.33 |
| of dry sludge) | |
| Oil removal efficiency/% | 99.78 |

Pursuant to a local standard of DB23/T1413-2010 Pollution Control Standard for Comprehensive Utilization of Oilfield Oily Sludge issued by the Heilongjiang Provincial Bureau of Quality and Technical Supervision, the treated sludge may be used for a well road and a well padding site.

### Embodiment 2

Based on 100 parts by weight, 6 parts of AES and super-amphiphilic molecular emulsifier according to a mass ratio of 2:1 or 1:4 or 4:1 (the AES and the super-amphiphilic molecular emulsifier were respectively 4 parts and 2 parts, 1.2 parts and 4.8 parts, and 4.8 parts and 1.2 parts), 8.5 parts of methylbenzene and 85.5 parts of pure water were weighed.

The surfactant, the methylbenzene and the pure water were put into a reactor sequentially, and stirred for 30 min at an agitation speed of 300 rpm under a room temperature to form three emulsion-type water-based detergents having different mass ratios of the surfactant.

The oily sludge was taken from the Liaohe oilfield, with the initial parameters including 57.20% of oil content, 38.98% of solid content and 3.82% of water content (all percentage contents were based on the weight), and the macrophotograph shown in FIG. 2(a).

Washing effect test: the mass ratio of the oily sludge to the water-based detergent was 1:4; the detergent was used for washing the oily sludge twice, 30 min for each time, at an agitation speed of 350 rpm under 80° C.; then, hot water with 80° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 2000 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing effects of the three emulsion-type water-based detergents having the different mass ratios of the surfactant to the oily sludge are shown in the table below.

| | | Super-amphiphilic | Residual oil ratio/% | |
|---|---|---|---|---|
| Mass | | molecular | (g/100 g of | Oil removal |
| ratio | AES/parts | emulsifier/parts | dry sludge) | efficiency/% |
| 2:1 | 4 | 2 | 0.71 | 99.52 |
| 1:4 | 1.2 | 4.8 | 1.74 | 98.81 |
| 4:1 | 4.8 | 1.2 | 2.45 | 98.33 |

### Embodiment 3

Based on 100 parts by weight, 1 part of AES and 1 part of super-amphiphilic molecular emulsifier according to a mass ratio of 1:1, 3 parts of oil-soluble component and 95 parts of pure water were respectively weighed, where the oil-soluble component was mixed benzene or dimethylbenzene or paraffin oil or gas-to-liquid or diesel oil.

The AES, the super-amphiphilic molecular emulsifier, one oil-soluble component and the aqueous phase were put into a reactor sequentially, and stirred for 25 min at an agitation speed of 150 rpm under a room temperature to form five emulsion-type water-based detergents having different oil-soluble components.

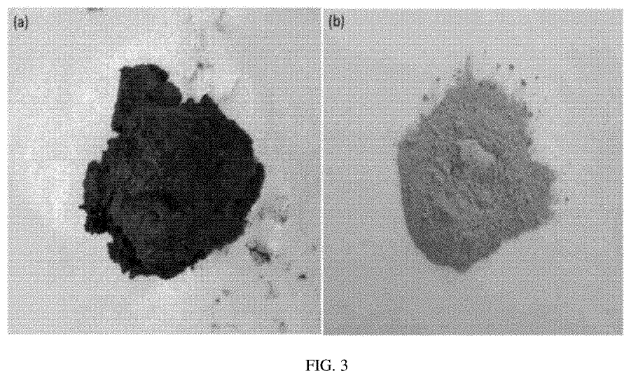

The oily sludge was taken from the Shengli oilfield, with the initial parameters including 8.13% of oil content, 41.59% of solid content and 50.28% of water content, and the macrophotograph shown in FIG. 3(a).

Washing effect test: the mass ratio of the oily sludge to the water-based detergent was 1:4; the detergent was used for washing the oily sludge once, 10 min for each time, at an agitation speed of 300 rpm under 60° C.; then, hot water with 60° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 1500 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing effects of the emulsion-type water-based detergents having the different oil-soluble components to the oily sludge are shown in the table below.

| Oil-soluble | Residual oil ratio/% | Oil removal |
|---|---|---|
| component | (g/100 g of dry sludge) | efficiency/% |
| Mixed benzene | 1.33 | 93.20 |
| Dimethylbenzene | 1.37 | 92.99 |
| Paraffin oil | 8.49 | 56.57 |
| Gas-to-liquid | 9.61 | 50.84 |
| Diesel oil | 11.14 | 43.01 |

### Embodiment 4

Based on 100 parts by weight, 1 part of AES and 1 part of super-amphiphilic molecular emulsifier according to a mass ratio of 1:1, 3 parts of methylbenzene and 95 parts of pure water were respectively weighed, put into a reactor sequentially, and stirred for 25 min at an agitation speed of 250 rpm under a room temperature to form a homogeneous and stable emulsion-type water-based detergent.

The oily sludge was taken from the Shengli oilfield, with the initial parameters including 8.13% of oil content, 41.59% of solid content and 50.28% of water content, and the macrophotograph shown in FIG. 3(a).

Washing effect test: the mass ratio of the oily sludge to the water-based detergent was 1:3 or 1:5 or 1:8; the detergent was used for washing the oily sludge once, 10 min for each time, at an agitation speed of 200 rpm under 60° C.; then, hot water with 60° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 2000 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing results of the oily sludge at different mass ratios of the oily sludge to the water-based detergent are shown in the table below.

| Mass ratio of oily | Residual oil ratio/% | |
|---|---|---|
| sludge to water-based | (g/100 g of | Oil removal |
| detergent | dry sludge) | efficiency/% |
| 1:3 | 1.48 | 92.43 |
| 1:5 | 1.10 | 94.37 |
| 1:8 | 0.56 | 97.14 |

### Embodiment 5

Based on 100 parts by weight, 1 part of AES and 1 part of super-amphiphilic molecular emulsifier according to a mass ratio of 1:1, 3 parts of methylbenzene and 95 parts of pure water were respectively weighed, put into a reactor sequentially, and stirred for 25 min at an agitation speed of 250 rpm under a room temperature to form a homogeneous and stable emulsion-type water-based detergent.

The oily sludge was taken from the Shengli oilfield, with the initial parameters including 8.13% of oil content, 41.59% of solid content and 50.28% of water content, and the macrophotograph shown in FIG. 3(a).

Washing effect test: the mass ratio of the oily sludge to the water-based detergent was 1:4; the detergent was used for washing the oily sludge once, 40 min for each time, at an agitation speed of 200 rpm under 60° C.; then, hot water with 60° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 2000 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing results of the oily sludge are shown in the table below, and the treated sludge is shown in FIG. 3(b).

| | |
|---|---|
| Initial oil content/% | 8.13 |
| Residual oil ratio/% (g/100 g | 1.74 |
| of dry sludge) | |
| Oil removal efficiency/% | 91.10 |

### Embodiment 6

Based on 100 parts by weight, 2.25 parts of AES and 2.25 parts of super-amphiphilic molecular emulsifier according to a mass ratio of 1:1, 7 parts of methylbenzene and 88.5 parts of pure water were respectively weighed, put into a reactor sequentially, and stirred for 30 min at an agitation speed of 400 rpm under a room temperature to form a homogeneous and stable emulsion-type water-based detergent.

The oily sludge was taken from the Liaohe oilfield, with the initial parameters including 57.20% of oil content, 38.98% of solid content and 3.82% of water content (all percentage contents were based on the weight), and the macrophotograph shown in FIG. 2(a).

Washing effect test: the mass ratio of the oily sludge to the water-based detergent was 1:4; the detergent was used for washing the oily sludge twice, 30 min for each time, at an agitation speed of 300 rpm under 70° C.; then, hot water with 70° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 2000 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing results of the oily sludge are shown in the table below.

| | |
|---|---|
| Initial oil content/% | 57.20 |
| Residual oil ratio/% (g/100 g | 1.21 |
| of dry sludge) | |
| Oil removal efficiency/% | 99.18 |

### Embodiment 7

Based on 100 parts by weight, 2.2.5 parts of AES and 2.25 parts of super-amphiphilic molecular emulsifier according to a mass ratio of 1:1, 7 parts of methylbenzene and 88.5 parts of aqueous phase were respectively weighed. The aqueous phase was respectively a NaCl solution having a concentration of 0.3 wt %, NaCl solution having a concentration of 0.5 wt %, a NaCl solution having a concentration of 1.0 wt %, a CaCl₂ solution having a concentration of 0.01 wt %, a CaCl₂ solution having a concentration of 0.07 wt %, a CaCl₂ solution having a concentration of 0.10 wt %, and mixed solution of NaCl and CaCl₂ (in the mixed solution, the concentration of NaCl was 0.3 wt %, and the concentration of CaCl₂ was 0.05 wt %).

The AES, the super-amphiphilic molecular emulsifier, the methylbenzene and one aqueous phase were put into a reactor sequentially, and stirred for 30 min at an agitation speed of 400 rpm under a room temperature to form seven emulsion-type water-based detergents having different aqueous phases.

The oily sludge was taken from the Liaohe oilfield, with the initial parameters including 57.20% of oil content, 38.98% of solid content and 3.82% of water content (all percentage contents were based on the weight), and the macrophotograph shown in FIG. 2(a).

Washing effect test: the mass ratio of the oily sludge to the water-based detergent was 1:4; the detergent was used for washing the oily sludge twice, 15 min for each time, at an agitation speed of 300 rpm under 60° C.; then, hot water with 60° C. was used for rinsing the oily sludge once, and whenever the washing of the detergent and the rinsing of the hot water were completed, a centrifugal machine was used for carrying out oil-water-solid three-phase separation (the rotational speed of the centrifugal machine was 2000 rpm, and the centrifuging time was 6 min); and at last, the sludge was dried under 105±1° C. to measure its residual oil ratio. Where:

Instrument: infrared spectrometer oil content analyzer (Oil 460)

Extractant: carbon tetrachloride (Tianjin Guangfu Fine Chemical Research Institute (exclusive use for infrared oil measurement)).

The washing results of the emulsion-type water-based detergents having the different aqueous phases to the oily sludge are shown in the table below.

| | Residual oil ratio/% | Oil removal |
|---|---|---|
| Aqueous phase | (g/100 g of dry sludge) | efficiency/% |
| 0.3 wt % NaCl solution | 1.10 | 99.25 |
| 0.5 wt % NaCl solution | 2.04 | 98.61 |
| 1.0 wt % NaCl solution | 2.69 | 98.17 |
| 0.01 wt % CaCl₂ solution | 0.86 | 99.41 |
| 0.07 wt % CaCl₂ solution | 0.67 | 99.54 |
| 0.10 wt % CaCl₂ solution | 1.08 | 99.26 |
| NaCl and CaCl₂ mixed solution | 0.91 | 99.38 |
| (the concentration of NaCl is 0.3 | | |
| wt %, and the concentration of | | |
| CaCl₂ is 0.05 wt %) | | |

The above embodiments are preferred embodiments of the present invention. However, the embodiments of the present invention are not limited by the above embodiments. Any change, modification, combination, simplification, improvement and the like made without departing from the spiritual essence and principle of the present invention should be an equivalent replacement manner, and all are included in a protection scope of the present invention.

1. An emulsion-type water-based detergent for oily sludge, comprising 2-10 parts of surfactant, 3-10 parts of oil-soluble component and the balance being aqueous phase, based on 100 parts by weight.

2. The emulsion-type water-based detergent for the oily sludge according to claim 1, wherein the surfactant comprises sodium fatty alcohol-polyoxyethylene ether sulfate (AES) and super-amphiphilic molecular emulsifier, and the mass ratio of the AES to the super-amphiphilic molecular emulsifier is 1:4-4:1.

3. The emulsion-type water-based detergent for the oily sludge according to claim 1, wherein the surfactant comprises the AES and the super-amphiphilic molecular emulsifier, and the mass ratio of the AES to the super-amphiphilic molecular emulsifier is 1:1-2:1.

4. The emulsion-type water-based detergent for the oily sludge according to claim 1, wherein the oil-soluble component is methylbenzene, dimethylbenzene, mixed benzene, diesel oil, paraffin oil or gas-to-liquid.

5. The emulsion-type water-based detergent for the oily sludge according to claim 1, wherein the aqueous phase is pure water, or NaCl solution having a concentration of less than 1 wt %, or CaCl₂ solution having a concentration of less than 0.1 wt %, or NaCl and CaCl₂ mixed solution having a concentration of NaCl being less than 1 wt % and the concentration of CaCl₂ being less than 0.1 wt %.

6. A method for preparing the emulsion-type water-based detergent for the oily sludge according to claim 1, comprising the following steps: based on 100 parts by weight, weighing 2-10 parts of surfactant, 3-10 parts of oil-soluble component and the balance being aqueous phase; and mixing the above components and stirring uniformly to obtain the homogeneous and stable emulsion-type water-based detergent.

7. The method for preparing the emulsion-type water-based detergent for the oily sludge according to claim 6, wherein the agitation speed is 150-500 rpm, the stirring time is 25-40 min, and the stirring temperature is room temperature.

8. A method for using the emulsion-type water-based detergent for the oily sludge according to claim 1, comprising the following steps: mixing the oily sludge with the emulsion-type water-based detergent according to a mass ratio of 1:3-1:8, stirring under 60-80° C., washing the oily sludge, subjecting a mixture to oil-water-solid three-phase separation after the washing is completed, and at last, rinsing a solid phase with hot water under the same temperature.

9. The method for using the emulsion-type water-based detergent for the oily sludge according to claim 8, wherein the stirring time is 10-40 min, and the agitation speed is 200-500 rpm.

10. The method for using the emulsion-type water-based detergent for the oily sludge according to claim 8, wherein the rotational speed in the three-phase separation is 1500-2500 rpm.

11. A method for using the emulsion-type water-based detergent for the oily sludge according to claim 2, comprising the following steps: mixing the oily sludge with the emulsion-type water-based detergent according to a mass ratio of 1:3-1:8, stirring under 60-80° C., washing the oily sludge, subjecting a mixture to oil-water-solid three-phase separation after the washing is completed, and at last, rinsing a solid phase with hot water under the same temperature.

12. A method for using the emulsion-type water-based detergent for the oily sludge according to claim 3, comprising the following steps: mixing the oily sludge with the emulsion-type water-based detergent according to a mass ratio of 1:3-1:8, stirring under 60-80° C., washing the oily sludge, subjecting a mixture to oil-water-solid three-phase separation after the washing is completed, and at last, rinsing a solid phase with hot water under the same temperature.

13. A method for using the emulsion-type water-based detergent for the oily sludge according to claim 4, comprising the following steps: mixing the oily sludge with the emulsion-type water-based detergent according to a mass ratio of 1:3-1:8, stirring under 60-80° C., washing the oily sludge, subjecting a mixture to oil-water-solid three-phase separation after the washing is completed, and at last, rinsing a solid phase with hot water under the same temperature.

14. A method for using the emulsion-type water-based detergent for the oily sludge according to claim 5, comprising the following steps: mixing the oily sludge with the emulsion-type water-based detergent according to a mass ratio of 1:3-1:8, stirring under 60-80° C., washing the oily sludge, subjecting a mixture to oil-water-solid three-phase separation after the washing is completed, and at last, rinsing a solid phase with hot water under the same temperature.

15. The method for using the emulsion-type water-based detergent for the oily sludge according to claim 9, wherein the stirring time is 10-40 min, and the agitation speed is 200-500 rpm.

16. The method for using the emulsion-type water-based detergent for the oily sludge according to claim 10, wherein the stirring time is 10-40 min, and the agitation speed is 200-500 rpm.

17. The method for using the emulsion-type water-based detergent for the oily sludge according to claim 11, wherein the stirring time is 10-40 min, and the agitation speed is 200-500 rpm.

18. The method for using the emulsion-type water-based detergent for the oily sludge according to claim 12, wherein the stirring time is 10-40 min, and the agitation speed is 200-500 rpm.

19. The method for using the emulsion-type water-based detergent for the oily sludge according to claim 9, wherein the rotational speed in the three-phase separation is 1500-2500 rpm.

20. The method for using the emulsion-type water-based detergent for the oily sludge according to claim 10, wherein the rotational speed in the three-phase separation is 1500-2500 rpm.
